(19) United States
(12) Patent Application Publication
(10) Pub. No.: US 2021/0383477 A1
(43) Pub. Date: Dec. 9, 2021

(54) Computer-Implemented Private Fund Structure for a Hybrid Investment Strategy

(71) Applicant: IMPACT CAPITAL FUNDS, INC., Stuart, FL (US)

(72) Inventor: Craig Price, Stuart, FL (US)

(73) Assignee: IMPACT CAPITAL FUNDS, INC., Stuart, FL (US)

(21) Appl. No.: 17/339,405

(22) Filed: Jun. 4, 2021

Related U.S. Application Data
(60) Provisional application No. 63/035,016, filed on Jun. 5, 2020.

(51) Int. Cl. G06Q 40/06; G06Q 40/02

(52) U.S. Cl. CPC G06Q 40/06; G06Q 40/025

(57) ABSTRACT

In one embodiment, a computer-implemented method relating to a hybrid investment strategy includes creating, from contributions by investors, a fund pool having at least first and second capital allocations, investing the first capital allocation according to a first investment strategy to generate a first strategy return, investing the second capital allocation according to a second investment strategy to generate a second strategy return, combining the first and second strategy returns to generate a combined return, allocating a first portion of the combined return to investors, allocating a second portion of the combined return to a designated organization, and allocating a third portion of the combined return to a fund sponsor.

### CROSS-REFERENCE TO RELATED APPLICATIONS

This application claims priority from U.S. Provisional Pat. App. No. 63/035,016, filed on Jun. 5, 2020, the contents of which are incorporated herein by reference in their entirety.

### TECHNICAL FIELD

The present disclosure relates generally to computer-implemented investment strategies.

### BACKGROUND

Investment strategies have traditionally sought to maximize returns with little concern for societal impact. Many succeed in generating wealth for their investors, typically a relatively small privileged group of individuals, or organizations headed by such individuals, but the lives of ordinary people, whose laws and protections, public institutions, taxes and infrastructure, labor, and often even their very funds, such as pensions, savings, and the like, facilitate the success of the investment strategies, remain unrewarded and are arguably even degraded by them. There is a need for computer-implemented investment strategies that account for the contributions of ordinary people, such as student loan borrowers or beneficiaries of non-profit organizations, and that reward them in positively impactful ways, such as lower interest rates, and promotion of their publicly oriented missions.

### OVERVIEW

Described herein is a computer-implemented method, system and computer-readable storage medium relating to a hybrid investment strategy, including creating, from contributions by investors, a fund pool having at least first and second capital allocations, investing the first capital allocation according to a first investment strategy to generate a first strategy return, investing the second capital allocation according to a second investment strategy to generate a second strategy return, combining the first and second strategy returns to generate a combined return, allocating a first portion of the combined return to investors, allocating a second portion of the combined return to a designated organization, and allocating a third portion of the combined return to a fund sponsor.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

In the drawings:

FIG. 1 is a block diagram showing the structure of a private fund 10 that employs a hybrid investment strategy in accordance with certain embodiments;

FIGS. 2A and 2B are block diagrams showing how gross returns and excess profits are determined;

FIG. 3 is a diagram showing the operation of a loan pool as the capital allocation 16b in accordance with certain embodiments;

FIG. 4 is a diagram showing the constitution of the equity portfolio and the manner in which its returns are generated in accordance with certain embodiments;

FIG. 5 is a diagram showing the composition of the blended return in accordance with certain embodiments;

FIG. 6 is a diagram showing the application of a hurdle rate, devised at inception of the loan, as an annual percentage return targeted by the fund in accordance with certain embodiments;

FIG. 7 is a diagram showing a profit share pledge that can be made by investors in accordance with certain embodiments;

FIG. 8 is a block diagram showing a computer implementation of a private fund that employs a hybrid investment strategy in accordance with certain embodiments;

FIG. 9 is a flow diagram of a computer-implemented method that employs a hybrid investment strategy in accordance with certain embodiments;

FIG. 10 is a diagram showing the use of APIs (Application Programming Interface) and API-enabled user interfaces in accordance with certain embodiments; and

FIG. 11 is a diagram of the vital role of the technological expedients used to execute a computer-implemented private fund in accordance with certain embodiments.

### DESCRIPTION OF EXAMPLE EMBODIMENTS

Example computer-implemented embodiments are described herein in the context of a private fund structure for a hybrid investment strategy. The following description is illustrative only and is not intended to be in any way limiting. Other embodiments will readily suggest themselves to those of ordinary skill in the art having the benefit of this disclosure. Reference will be made in detail to implementations of the example embodiments as illustrated in the accompanying drawings. The same reference indicators will be used to the extent possible throughout the drawings and the following description to refer to the same or like items.

In the description of example embodiments that follows, references to “one embodiment”, “an embodiment”, “an example embodiment”, “certain embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. The term “exemplary” when used herein means “serving as an example, instance or illustration.” Any embodiment described herein as “exemplary” is not necessarily to be construed as preferred or advantageous over other embodiments.

In the interest of clarity, not all of the routine features of the implementations described herein are shown and described. It will be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

In accordance with this disclosure, the components, process steps, and/or data structures described herein may be implemented using various types of operating systems, computing platforms, computer programs, and/or general purpose machines. Devices of a less general purpose nature, such as hardwired devices, field programmable gate arrays (FPGAs), application specific integrated circuits (ASICs), or the like, may also be used without departing from the scope and spirit of the inventive concepts disclosed herein. Where a method comprising a series of process steps is implemented by a computer or a machine and those process steps can be stored as a series of instructions readable by the machine, they may be stored on a tangible medium such as a computer memory device (e.g., ROM (Read Only Memory), PROM (Programmable Read Only Memory), EEPROM (Electrically Erasable Programmable Read Only Memory), FLASH Memory, Jump Drive, and the like), magnetic storage medium (e.g., tape, magnetic disk drive, and the like), optical storage medium (e.g., CD-ROM, DVD-ROM, paper card, paper tape and the like) and other types of program memory.

Herein, reference to a computer-readable or machine-readable storage medium encompasses one or more non-transitory, tangible storage media possessing structure. As an example and not by way of limitation, a computer-readable storage medium may include a semiconductor-based circuit or device or other IC (such, as for example, a field-programmable gate array (FPGA) or an ASIC), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. § 101. Herein, reference to a computer-readable storage medium excludes transitory forms of signal transmission (such as a propagating electrical or electromagnetic signal per se) to the extent that they are not eligible for patent protection under 35 U.S.C. § 101. A computer-readable non-transitory storage medium may be volatile, nonvolatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

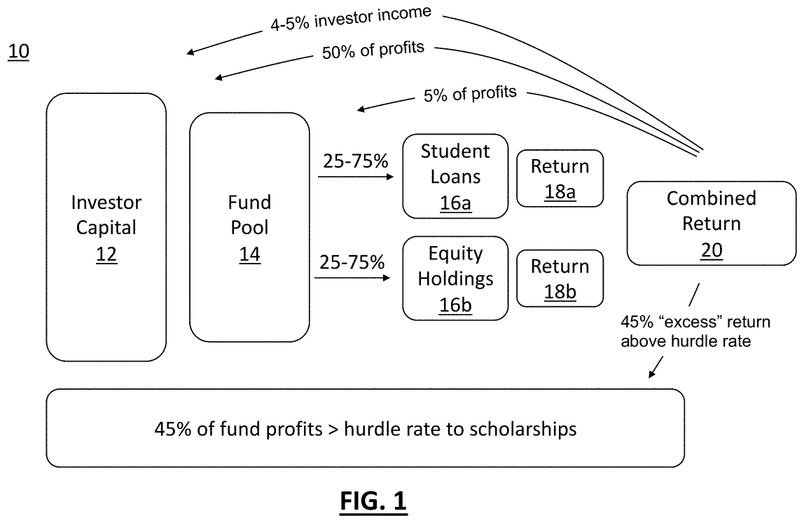

FIG. 1 is a block diagram showing the structure of a computer-implemented private fund 10 that employs a hybrid investment strategy in accordance with certain embodiments. In fund 10, investor capital 12 is used to create a fund pool 14, from which one or more capital allocations, such as first and second capital allocations 16a and 16b, are derived. In certain embodiments, the capital allocations (16 collectively) each can comprise about 25-75% of the fund pool, although this range is not by way of limitation. In certain embodiments, the capital allocations 16 are each invested in accordance with a different investment strategy, and each generates a corresponding return 18a, 18b (18 collectively). The returns may be from loan income, stock dividends, option income, and capital gains, for example. One example investment strategy is unsecured amortizing loans, such as student loans, which may be extended to student borrowers at below-market interest rates. Low interest loans can also be extended to immigrants who have limited credit history, and who are often individuals with professional credentials from their country of origin, but may otherwise be forced to pay high interest rates on loans to become certified or accredited to work in the same field within the country to which they immigrated, for example due to an unsubstantiated credit history in that country. Another example investment strategy is equity holdings, for example a group of 20-30 stocks as further detailed below.

In certain embodiments, returns 18a, 18b from the investment strategies are combined to generate a combined return 20.

The combination of the returns 18a, 18b from distinct asset classes—loans and equities in this example—can be used to benefit various stakeholders who profit from the combined fund returns 20: impact investors who provide capital, fund borrowers who refinance higher cost loans on more favorable terms, and universities or non-profit organizations seeking capital for their mission. More or fewer stakeholders can also be benefited in certain embodiments.

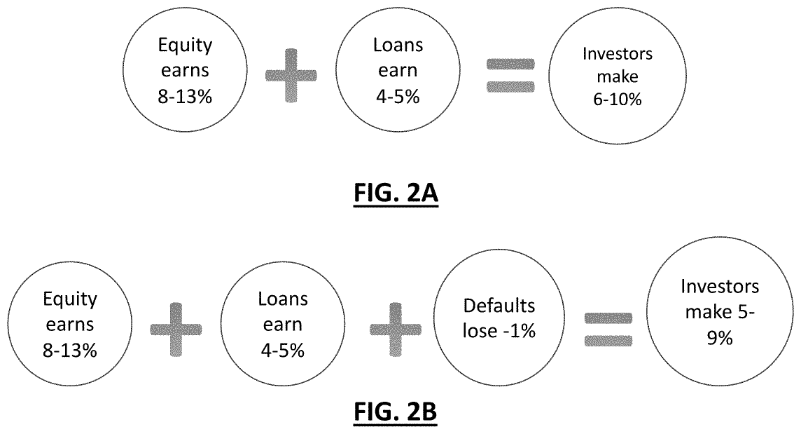

By combining the returns 18 from the different capital allocations 16 into combined return 20, higher returns historically earned by equities in capital allocation 16b are used to subsidize the interest rates offered to the fund's borrowers in capital allocation 16a. This return-sharing feature of the fund enables the loan pool to offer below-market interest rates to qualified borrowers while still generating profits for investors, as illustrated diagrammatically in FIGS. 2A and 2B.

The example dual investment strategy of low interest rate loans—combined with a profitable equity strategy—has many potential applications where access to low cost credit is impactful. The loan capital allocation 16a can focus solely on certain types of borrowers like college graduates with loans, other types of secured or unsecured loans, or non-profit organizations who want to fund an impact program requiring credit, and the like.

Student loan debt is a crushing burden for many college graduates. In certain embodiments, money can be lent to graduates of a university who in turn refinance their higher-rate student loans on more favorable terms. In certain embodiments, alumni who are accredited investors can provide the investor capital 12 for lending out via the fund, and in turn, they themselves may earn a reasonable return while helping the next generation of alumni from their alma mater. Universities themselves may find it advantageous to invest their own capital in the fund, thus creating a lending facility to help their own graduates, while retaining investment return for their institutional priorities.

Apart from a loan pool to assist individual borrowers, for example students as described above, in certain embodiments, below market rate loans can be offered to non-profit organizations seeking financing for mission-driven projects. One such example is an entity introducing rural African farmers to solar-powered milk chillers, to keep their cow and goat milk fresh longer before selling at market. This approach reduces the farmers' reliance on diesel generators, reduces carbon emissions, and improves reliability due to the abundance of sunshine. The solar chillers cost $77,000 each, and capital allocations 16 of private fund structure 10 can be used to provide their farmers access to below-market rate loans. In addition, the entity could invest its own capital in the private fund structure 10, specifically to fund this mission example. Co-investment from other investors who support the entity's mission could increase the farmers' access to low cost capital, creating a win-win impact.

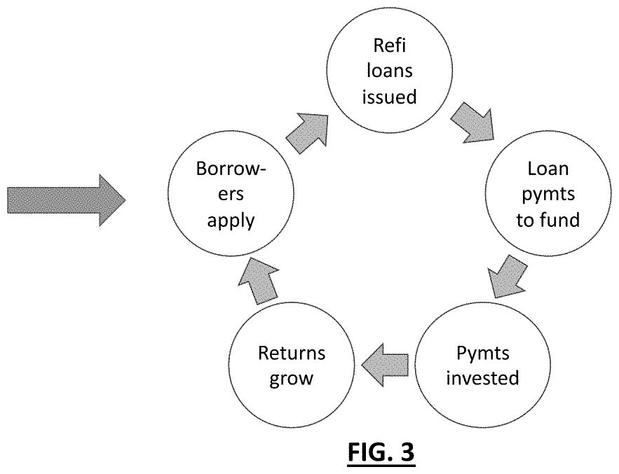

FIG. 3 is a diagram showing the operation of a loan pool as the capital allocation 16a in accordance with certain embodiments. The operation can be implemented in a digital lending program in certain embodiments. In one embodiment, borrowers apply for a loan, approved loans are issued, payments on the loan are applied to the fund, the fund invests the received loan payments, and returns of the fund may grow over time allowing more loans to be made to borrowers.

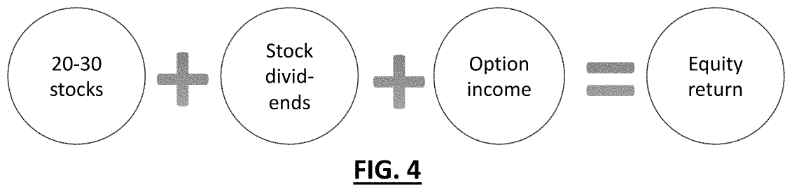

FIG. 4 is a diagram showing the constitution of the equity portfolio of the capital allocation 16b example and the manner in which its returns are generated. Specifically, in certain embodiments, the portfolio comprises a holding of a group of about 20-30 select stocks. Price movement of its 20-30 stocks, dividends received from those stocks, and income from selling volatility via call options (selling call options is a form of hedging) comprise the means by which returns are generated from the stocks. Historically, the portfolio dividends, plus the option income, produce about 4-7% return per year.

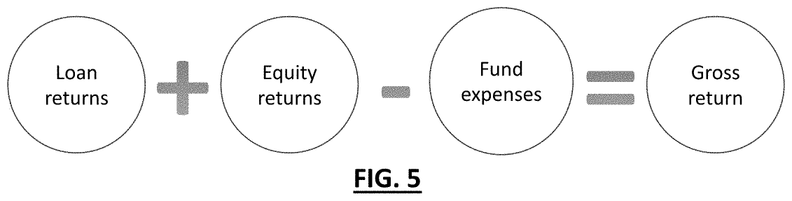

FIG. 5 is a diagram showing the composition of the blended return in accordance with certain embodiments, wherein the combination of loan returns and equity returns, less fund expenses, comprise the gross return.

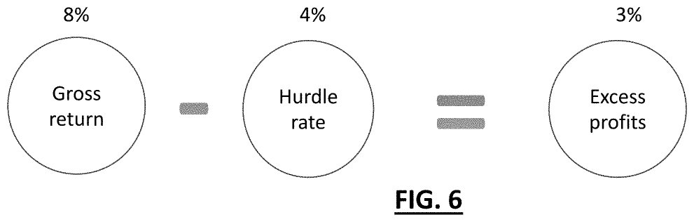

FIG. 6 is a diagram showing the application of a hurdle rate, devised at inception of the fund, as an annual percentage return targeted by the fund. When the annual hurdle rate, 4% in this example, is exceeded, the excess profits accrue toward a “Promote Payment” that is split among the three fund stakeholders (investors, university or non-profit organization, fund manager) at the end of the investment term. Alternately, in certain embodiments, the fund may distribute its excess profits annually, instead of accruing them. This feature of a fund is known by investors at the time of the fund offering.

Returning to FIG. 1, in certain embodiments, income to the investors may be drawn from the combined return 20, for example about 4-5%, as shown. In certain embodiments, about 50% of profits from the combined income return 20 are reallocated as investor capital 12. In certain embodiments, about 5% of profits from the combined income return 20 are paid to the fund sponsor or reinvested into the fund pool 14. In certain embodiments, about 45% of fund profits greater than the example hurdle rate of about 4% may be reserved for educational scholarships. It will be appreciated that actual values applied may be different than those discussed above by way of example only.

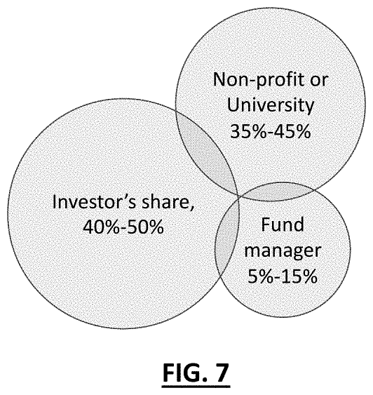

In certain embodiments, a ‘Profit-share Pledge’ may be made by each investor, comprising each investor's promise to share a percentage of the excess profits with a designated university or other charitable beneficiary. An example of such an arrangement is shown in FIG. 7. It will be appreciated that actual values applied may be different than those shown in FIG. 7 by way of example only.

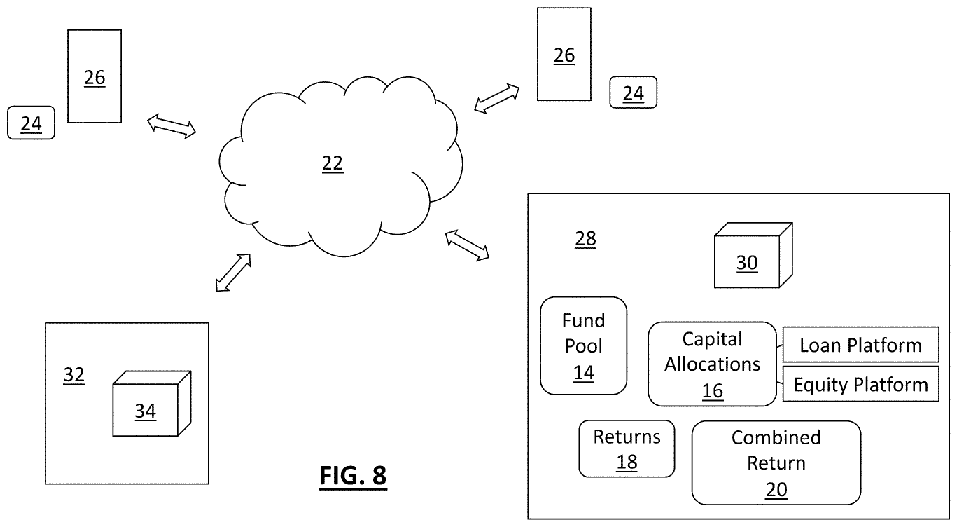

FIG. 8 is a block diagram showing a computer implementation of a private fund that employs a hybrid investment strategy in accordance with certain embodiments. A network 22, such as a public or private intranet or the Internet, or a combination of these, provides a medium of communication between the various components and actors in the computer implementation. One or more investors, using computing devices 24, in cooperation with institutions 26 such as banks, direct funds, for example electronically, to a fund administrator institution 28. In this manner digital onboarding of investors' capital into the investment fund is facilitated. Computing devices (not shown) of institutions 26, and a computing device 30 (for example a server) of fund administrator institution 28 together coordinate the communication and fund transfers to build a fund pool such as fund pool 14, make capital allocations 16, receive returns 18, and aggregate them into combined return 20 as described above. These actions can be coordinated with other institutions 32, using one or more associated servers 34. One feature of the described arrangement is the automated bifurcation of investor capital to: a digital loan origination platform, and equity investment platform (and others, if applicable). Other features include:
Digital application, approval, origination and disbursement of loans to fund borrowers
Digital transfer of monthly loan payments via ACH to the custodian financial institution
Automated transfer of payments, minus applicable service fees, to investment strategy for such payments
Capital allocated to the equity investment manager is digitally transferred to the custodian financial institution, and the capital is auto-invested into the manager's strategy
The various return streams are aggregated electronically and allocated by formula to the respective stakeholders: investors, universities/non-profits, and the company
Transactions at the fund-level, investor-level, and borrower-level are digitally captured and managed in a customized fund administration computer program.

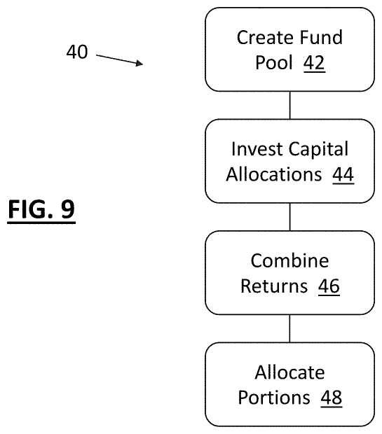

It should be understood that each computing device and server mentioned herein can take the form of one or more such devices, running at the same location, or at separate locations in communication with one another through network 22 and/or other networks not shown. Computer code stored in volatile or non-volatile memories, or other storage media, is retrieved and executed by processors of these devices to implement the processes and investment structure described herein. In certain embodiments, the code is executed to perform a computer-implemented method 40 that employs a hybrid investment strategy in accordance with certain embodiments, as shown in FIG. 9. For example, at 42, a fund pool 14 (FIG. 1) having at least first and second capital allocations 16 is created. At 44, the first and second capital allocations are invested according to respective first and second investment strategies to generate respective first and second strategy returns 18. At 46, the first and second strategy returns are combined. At 48, portions of the combined returns are allocated for example as investor income, profits, etc., as described above.

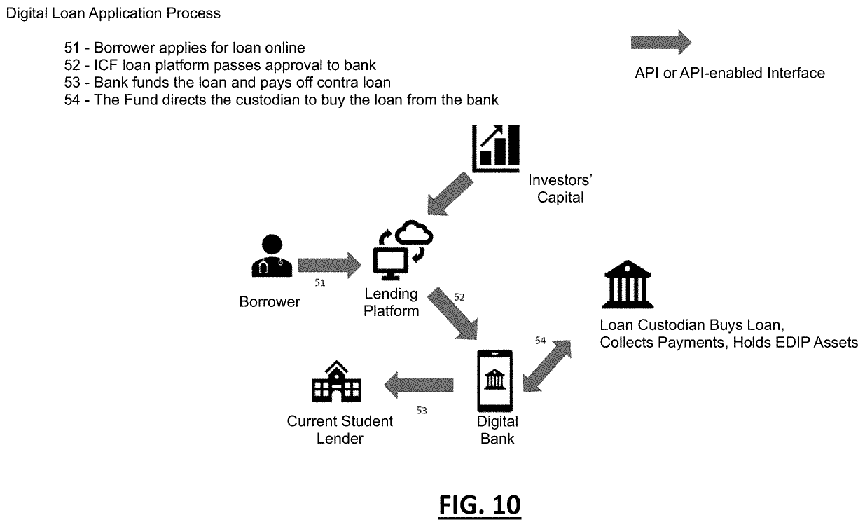

FIG. 10 is a diagram showing the use of APIs (Application Programming Interfaces) and API-enabled user interfaces in accordance with certain embodiments. API 51 interfaces a borrower to a lending platform; API 52 facilitates the passage of the loan approval to a digital bank; API 53 facilitates funding the loan and paying off the contra loan; and API 54 facilitates directing the custodian to by the loan from the bank.

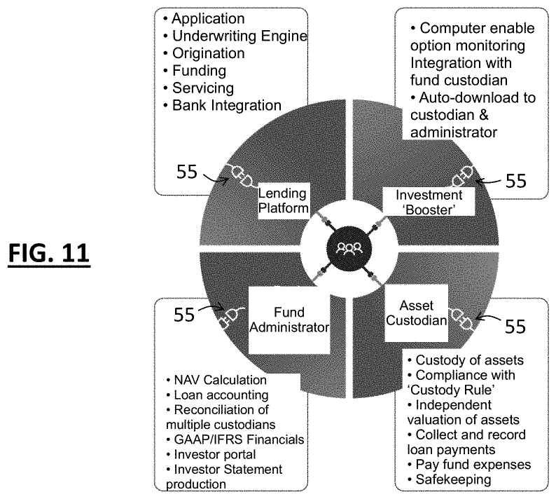

FIG. 11 is a diagram of the vital role of the technological expedients used to execute the computer-implemented private fund 10 in accordance with certain embodiments. As explained above, APIs and API-enabled user interfaces 55 can be used to effect the electronic interfacing among the components, users and platforms.

In certain embodiments, users are able to engage and participate in computer-implemented investment strategies relating to private fund 10 through user-interfaces at respective computing devices 24 (FIG. 8). A user-interface may include, but is not limited to, a touch screen, keyboard, microphone, display or other user-input device. The user-interface may be coupled to an application and/or browser running on computing device 24 for communicating over network 22. Operations may be carried out through the application and/or a browser to perform operations as described herein. For example, these operations may be implemented as a software-as-a-service (SaaS) over the World Wide Web, or as another web-based or cloud computing service and system. In another example, these operations may be implemented through applications provided as stand-alone applications downloadable from an application store or as part of enterprise software for an organization. These examples are illustrative and not intended to be limiting.

While embodiments and applications have been shown and described, it would be apparent to those skilled in the art having the benefit of this disclosure that many more modifications than mentioned above are possible without departing from the inventive concepts disclosed herein. The invention, therefore, is not to be restricted based on the foregoing description. This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

What is claimed is:

1. A computer-implemented method comprising:
creating, from contributions by investors, a fund pool having at least first and second capital allocations;
investing the first capital allocation according to a first investment strategy to generate a first strategy return;
investing the second capital allocation according to a second investment strategy to generate a second strategy return;
combining the first and second strategy returns to generate a combined return;
allocating a first portion of the combined return to investors; and
allocating a second portion of the combined return to a designated organization.

2. The method of claim 1, further comprising allocating a third portion of the combined return to a fund sponsor.

3. The method of claim 1, wherein at least one of the first or second capital allocations comprises about 25-75% the fund pool.

4. The method of claim 1, wherein the first investment strategy is unsecured amortizing loans.

5. The method of claim 4, wherein the second investment strategy is not unsecured amortizing loans.

6. The method of claim 4, wherein the amortizing loans are student loans.

7. The method of claim 4, wherein the amortizing loans are at below-market interest rates.

8. The method of claim 1, wherein the investors designate a non-profit organization as a partial beneficiary of fund returns.

9. The method of claim 1, wherein the first investment strategy is equities.

10. The method of claim 9, wherein the equities is a portfolio of about 20-30 stocks.

11. The method of claim 1, further comprising setting a hurdle rate as an targeted annual percentage return.

12. The method of claim 11, further comprising distributing payments when the hurdle rate is exceeded.

13. The method of claim 1, wherein the allocated first portion is about 4-5%.

14. The method of claim 1, further comprising reallocating from the combined return about 50% as investor capital.

15. The method of claim 1, further comprising reinvesting about 5% of profits from the combined return into the fund pool.

16. The method of claim 1, further comprising reserving about 45% of fund profits greater than 4% for educational scholarships.

17. A non-transitory computer-readable medium comprising logic, the logic when executed by one or more processors configured to cause the one or more processors to perform operations comprising:
creating, from contributions by investors, a fund pool having at least first and second capital allocations;
investing the first capital allocation according to a first investment strategy to generate a first strategy return;
investing the second capital allocation according to a second investment strategy to generate a second strategy return;
combining the first and second strategy returns to generate a combined return;
allocating a first portion of the combined return to investors; and
allocating a second portion of the combined return to a designated organization.

18. The non-transitory computer-readable medium of claim 17, further comprising allocating a third portion of the combined return to a fund sponsor.

19. The non-transitory computer-readable medium of claim 17, wherein at least one of the first or second capital allocations comprises about 25-75% the fund pool.

20. The non-transitory computer-readable medium of claim 17, wherein the first investment strategy is unsecured amortizing loans.
